(19) United States
(12) Patent Application Publication
(10) Pub. No.: US 2017/0241388 A1
(43) Pub. Date: Aug. 24, 2017

(54) Filter assembly comprising a plurality of filter elements

(71) Applicant: MANN+HUMMEL GMBH, Ludwigsburg (DE)

(72) Inventors: Karl-Ernst Hummel, Bietigheim-Bissingen (DE); Michael Fasold, Auenwald (DE); Ulrich Dehnen, Kornwestheim (DE); Christopher Marc Sturgess, Korntal (DE); Stefan Eichinger, Gerlingen (DE); Thomas Friederich, Stuttgart (DE); Joerg Menssen, Eschede (DE); Armando Labarta, Ludwigsburg (DE)

(21) Appl. No.: 15/432,981

(22) Filed: Feb. 15, 2017

(30) Foreign Application Priority Data
Feb. 18, 2016 (DE) 10 2016 001 851.8

(51) Int. Cl. F02M 37/22; F01M 1/10; B01D 35/30; B01D 29/52; B01D 29/07

(52) U.S. Cl. CPC F02M 37/22; B01D 29/52; B01D 29/07; B01D 35/30; F01M 1/10; F01M 2001/1057

(57) ABSTRACT

A filter assembly for a fluid to be filtered, in particular fuel or oil, has a filter housing having a housing lower part that is configured as a single piece and has at least one fluid inlet for the fluid to be filtered and a plurality of filter pots that are arranged next to one another side by side in a shared plane and are fluidically connected to one another via side wall passages An upper housing part closes the filter pots and has a fluid manifold that has at least one fluid outlet for the filtered fluid flowing out from the filter pots. At least two filter elements, one being arranged in each of the filter pots of the filter housing. The filter assembly is a more inexpensively-manufactured and as configured for installation even in confined installation spaces, so as to accommodate a sufficiently large filter surface for a predetermined volume flow of a fluid to be filtered.

### TECHNICAL FIELD

The present invention relates to a filter assembly for a fluid to be filtered, in particular, fuel or oil, comprising a filter housing and comprising at least two filter elements.

### BACKGROUND

Filter elements are used in motor vehicles, for instance, to remove impurities from operating fluids like fuel and oil. Typically, exactly one filter element is provided for a fluid to be filtered. The size of the filter element limits a maximum possible volume flow of the fluid to be filtered. However, the installation space available is not always large enough or shaped as needed.

EP 0 991 457 B1 discloses a filter system in which a plurality of separate, hollow, cylindrical filter housings each comprising a filter element are bolted onto a shared filter head. The filter head is configured so that a fluid is able to flow in parallel through the filter housings comprising the filter elements. The filter head comprises connections for introducing the fluid to be filtered and for discharging the filtered fluid. The specific filter head is intended to reduce the number of connecting lines required in order to connect the plurality of filter housings to a pre-filtration line for a fluid to be filtered. However, the elaborate filter head significantly increases the overall height in the vertical direction.

US 2011/0 089 101 A1 discloses a fuel filter in which two hollow, cylindrical filter cartridges allowing parallel through-flow are arranged in a shared housing interior of a filter housing, wherein each filter cartridge is surrounded with a hydrophobic mesh in order to separate out water contained in the fuel. The filter cartridges are mounted onto maintenance covers screwed into the filter housing from the underside, so that the filter cartridges can be easily replaced. Because the filter cartridges are arranged in the shared housing interior, only a slight—if any—reduction in the overall size of the fuel filter as a whole is produced, in comparison to the use of a larger filter cartridge. Moreover, there is no increase in flexibility for the design of an outer contour of the filter housing.

### SUMMARY

This disclosure addresses the problem of providing a more inexpensively-manufactured filter assembly that makes it possible, even in confined installation spaces, to accommodate a sufficiently large filter surface for a predetermined volume flow of a fluid to be filtered.

According to the present invention, a filter assembly for a fluid to be filtered, in particular fuel or oil, is provided with a filter housing. The filter housing has a housing lower part, configured as a single piece. This makes the housing lower part simple and inexpensive to fabricate. At least one fluid inlet for the fluid to be filtered is provided in the housing lower part. The housing lower part is configured so as to comprise a plurality of filter pots. The filter pots are arranged side by side, adjacent to one another in a shared plane. The housing lower part can thus be flexibly adapted to an installation space of a complex or jagged shape, in particular, to a very flat installation space. The filter pots are fluidically connected to one another via side wall passages. This makes it possible to endow the filter pots with a parallel through-flow. The side wall passages may be configured as radial channels, preferably as slits in the side walls, which are open from a separation plane of the housing parts, in order to achieve an unencumbered demolding therethrough.

The plurality of filter pots also make it possible to filter a predetermined volume flow of the fluid. The filter housing further comprises a housing upper part for closing the filter pots. The housing upper part is typically placed in a sealing, i.e., fluid-tight manner on the filter housing. For this purpose, the filter housing and housing upper part may be adhered to one another. A fluid manifold that comprises at least one fluid outlet for the filtered fluid flowing out of the filter pots is configured on the housing upper part. The filter assembly additionally comprises at least two filter elements, one being arranged in each of the filter pots of the filter housing. Each of the filter pots is thereby divided into an antechamber for the fluid to be filtered and a post-filtration chamber for filtered fluid. The fluid manifold is typically opened to the post-filtration chambers of each of the filter pots. That is to say, filtered fluid can flow from the respective post-filtration chambers into the fluid manifold.

It may be provided that the filter assembly has, in each case, more than one fluid inlet and/or fluid outlet, such as a pre-filtration liquid inlet and an inlet for fuel returned from an internal combustion engine, and/or two post-filtration liquid outlets that can be connected to separated fuel supply systems.

The housing upper part may be configured as a single piece or as a plurality of pieces. It is configured so as to comprise one cover element for each filter pot. With a multi-piece housing upper part, at least two of the cover elements may be structurally identical.

An advantageous embodiment provides that the cover elements each comprise a lengthwise segment of the fluid manifold. This makes it possible to achieve a compact structural design.

In an especially preferred embodiment, it is provided that the cover element and the respectively-associated lengthwise segment are integrated as a single piece with one another. The fluid manifold is then configured at least in some sections as a component of the housing upper part. This makes it possible to simplify the fabrication and mounting of the filter assembly.

In an advantageous embodiment, the fluid manifold is longitudinally divided. Preferably, a lower-side partial section of the fluid manifold is formed of a lengthwise segment that is integrated with a cover element. This further simplifies fabrication and enables an especially flat structural design of the filter assembly.

In a preferred embodiment, the filter assembly is characterized in that the filter elements are supported on the housing upper part. Advantageously, the filter elements are clamped, embedded, or integrally fastened, preferably welded, onto the housing upper part. Alternatively or additionally, the filter element may be plugged—preferably, plugged in a sealing manner—onto a socket section of the housing upper part. The socket section may be sealed off by an O-ring or a sealing seat, which is preferably present at or abuts against an end plate of the filter element.

This simplifies the mounting of the filter assembly. The filter elements may be pre-mounted onto the housing upper part, for this purpose. At the same time, it can be ensured that the filter elements are attached in a fluid-tight manner to the housing upper part, so that no leakage flow will occur between the respective antechambers and post-filtration chambers.

In an advantageous embodiment, the filter elements are round elements, in particular, with a filter medium folded into the shape of a star. This enables an especially compact design for the individual filter pots. In an alternative, also advantageous embodiment, the filter elements are flat elements, in particular with a filter medium folded into a zigzag shape. This enables an exceptionally flat design for the filter assembly.

Preferably, at least two of the filter pots are connected fluidically in parallel to one another on the pre-filtration side. The fluid can then flow in parallel through the filter elements in the at least two filter pots. That is to say, the antechambers in the filter pots are fluidically connected to one another. This makes it possible to obtain a larger effective overall filter element when individual small filter elements are being used.

In an advantageous development, it is provided that a heating element for the fluid and/or a water separator for separating out water contained in the fluid is/are arranged in one of the filter pots, preferably in a filter pot that allows a serial through-flow, which is especially preferably arranged on the inflow side as a first filter pot of the filter assembly or is a central pot that allows a serial through-flow. The filter pot allowing a serial through-flow is thus connected upstream or downstream of the other filter pots. This makes it possible to integrate additional functions such as heating of the fluid and/or separation of water from the fluid. The consequently requisite equipment need then be provided only once for the entire filter assembly, and not for each individual filter pot or each individual filter element, ie., as a plurality.

In an advantageous embodiment, it is provided that the housing lower part is configured as an injection-molded part. Preferably, the housing lower part is composed of polyamide. Particularly preferably, PA66 is used. The housing upper part is typically also configured as an injection-molded part, preferably made of polyamide. Advantageously, one or both housing parts may be at least partially composed of an electrically conductive plastic, which is advantageous in order to be able to discharge static electricity created by the through-flow of fuel. Here, the filter assembly in an especially advantageous embodiment may have at least one connection for establishing electrical contact for discharging static electricity, which is preferably arranged at the fluid inlet and/or fluid outlet.

In an advantageous embodiment, the filter pots differ from one another in the respective overall heights and/or diameters thereof. The filter pots are consequently configured so as to have different depths. This enables an especially favorable fit of the filter assembly into jagged installation spaces.

In another embodiment, it may be provided that the housing upper part and the housing lower part are connected to one another in a fluid-tight manner, in particular, welded together on a separation plane. The separation plane may then run normal to a longitudinal axis of the filter pots, or run at an angle to the longitudinal axis of the filter pots. Alternatively, the separation plane may be stepped, in particular, have a plurality of steps, wherein preferably at least one separation plane section that runs normal to a longitudinal axis of the filter pots is present and at least one separation plane section that runs at an angle to the longitudinal axis of the filter pots is present. This enables even better adaptation to an installation space, not only in the plane, but also at an inclination of a limitation of the installation space.

A welding seam provided between the housing lower part and the housing upper part typically runs circumferentially around. The welding seam may advantageously run in a seam plane. Alternatively, the welding seam may extend along a three-dimensional curve. Welding enables a simple, inexpensive, space-conserving, and reliably fluid-tight connection of the housing lower part to the housing upper part.

Finally, it may be provided, alternatively or additionally, that a bracing is provided between at least two adjacent filter pots, the bracing preferably constituting or comprising at least one fastening device, in particular, a fastening eyelet or fastening tab, which can be used to fasten the filter assembly, for example, onto a motor vehicle, in particular, in the undercarriage region.

The filter pots may each have a round, elliptical, polygonal, in particular, rectangular or hexagonal cross-sectional shape. Preferably, all of the filter pots of the filter assembly have the same cross-sectional shape. Alternatively, however, different cross-sectional shapes may be combined within one filter assembly. Selecting a suitable cross-sectional shape for the filter pots makes it possible to further adapt the filter assembly to the installation space available.

Additional advantages of the invention result from the description and the drawings. The features described in the foregoing and elaborated even further may be used individually by themselves or with other features in any combination.

### BRIEF DESCRIPTION OF THE DRAWINGS

In the drawings:

FIG. 1a illustrates a schematic top view of a first embodiment of a filter assembly according to the present invention, comprising four substantially cylindrical filter pots arranged in a row;

FIG. 1b illustrates a schematic side view of the filter assembly from FIG. 1a;

FIG. 1c illustrates a schematic longitudinal section along the plane A-A through the filter assembly from FIG. 1a;

FIG. 2a illustrates a schematic top view of a second embodiment of a filter assembly according to the present invention, comprising six essentially cylindrical filter pots of different depths in a complex arrangement;

FIG. 2b illustrates a schematic sectional view along the plane A-A through the filter assembly from FIG. 2a;

FIG. 3a illustrates a schematic top view of a third embodiment of a filter assembly according to the present invention, comprising six essentially rectangular filter pots arranged next to one another;

FIG. 3b illustrates a schematic side view of the filter assembly from FIG. 3a;

FIG. 3c illustrates a schematic longitudinal section along the plane A-A through the filter assembly from FIG. 3a;

FIG. 3d illustrates a schematic cross-section along the offset half-planes B-B through the filter assembly from FIG. 3a;

FIG. 4a illustrates a greatly-abstracted top view of a fourth embodiment of a filter assembly according to the present invention, comprising five rectangular filter pots arranged in two offset rows;

FIG. 4b illustrates an abstracted top view of a fifth embodiment of a filter assembly according to the present invention, comprising four cross-sectionally hexagonal filter pots that are arranged offset relative to one another;

FIG. 4c illustrates an abstracted top view of a sixth embodiment of a filter assembly according to the present invention, comprising five cylindrical filter pots, one of which is configured as a central pot allowing a through-flow serial to the others and comprising a water separator and a heating element;

FIG. 5 illustrates a perspective view of another embodiment of the filter assembly according to the present invention, comprising fastening eyelets between the filter pots;

FIG. 6 illustrates a perspective view of yet another embodiment of the filter assembly according to the present invention, comprising connections to the electrical contact;

FIG. 7 illustrates a perspective view of an alternative embodiment of the filter assembly according to the present invention, comprising two fluid inlets and outlets;

FIGS. 8a and 8b illustrate perspective views of an alternative embodiment of the filter assembly according to the present invention, comprising an inclined separation plane of the housing part; and

FIGS. 9a and 9b illustrate longitudinal sectional views each of a filter pot having an accommodated filter element, which is plugged onto a socket section of the housing upper part.

### DETAILED DESCRIPTION

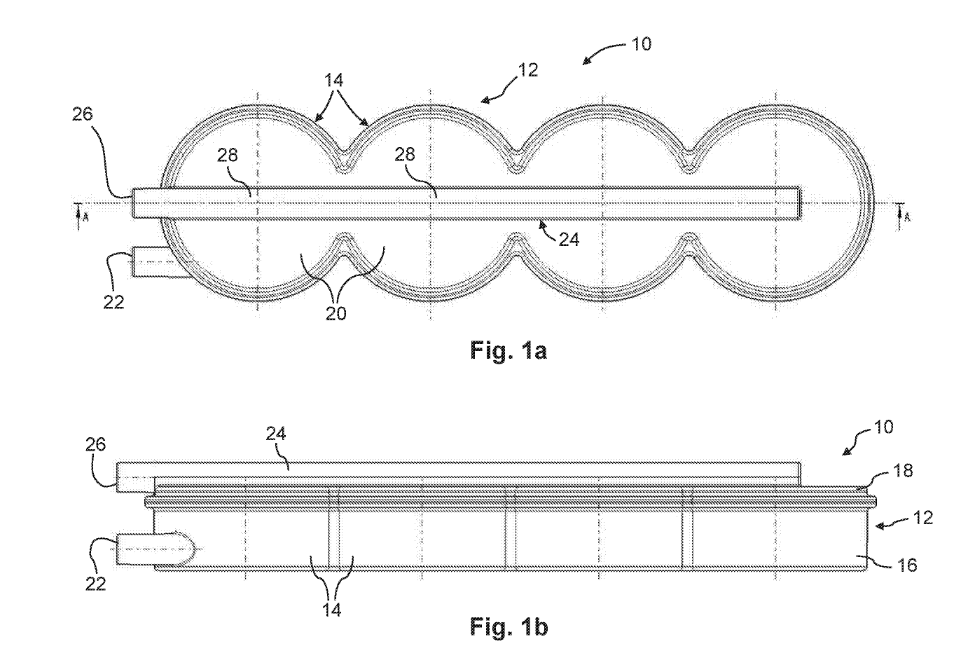

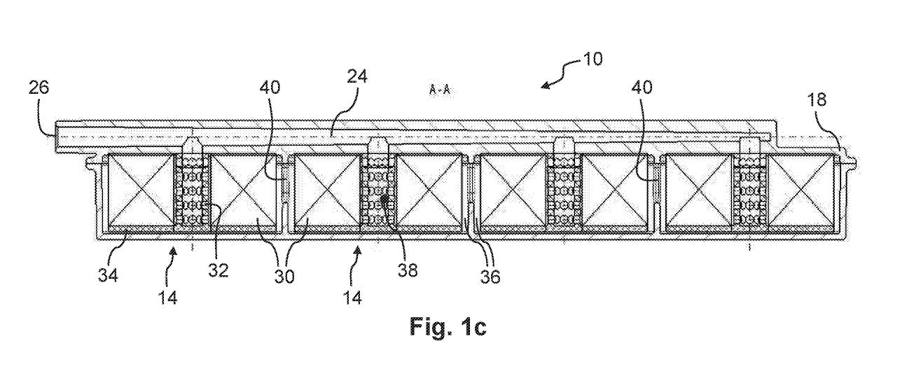

FIG. a illustrates a schematic top view of a first embodiment of a filter assembly 10 according to the present invention. FIG. 1b depicts the filter assembly 10 from FIG. 1a in a schematic side view. A filter housing 12 of the filter assembly 10 comprises, for example, four essentially cylindrical filter pots 14. The filter pots 14 are here arranged next to one another along a straight line. The filter pots 14 are here arranged lying side by side in such a manner that side walls of adjacent filter pots 14 merge into one another. The filter pots 14 in the filter assembly 10 then lie in one shared plane.

The filter housing 12 comprises a housing lower part 16 and a housing upper part 18. The housing lower part 16 and the housing upper part 18 are in each case configured as a single piece, each as an injection-molded part. The two housing parts may be composed, for example, of polyamide. The housing upper part 18 is welded onto the housing lower part 16 in a fluid-tight manner. The housing upper part 18 constitutes four cover elements 20 for the four filter pots 14. Each of the cover elements 20 completely covers the respectively-associated filter pot 14.

The filter assembly 10 has a fluid inlet 22. The fluid inlet 22 is arranged on the housing lower part 16. Fluid to be filtered can flow through the fluid inlet 22 into the filter pots 14. The filter assembly 10 further comprises a fluid manifold 24. The fluid manifold 24 is configured on the housing upper part 18. The fluid manifold 24 opens into a fluid outlet 26. Filtered fluid can flow out from the filter housing 12 through the fluid outlet 26. The fluid manifold 24 is formed of lengthwise segments 28 that are each configured on one of the cover elements 20. In the embodiment of FIGS. 1a and 1b, the lengthwise segments 28 merge seamlessly into one another. The fluid manifold 24 is configured as a single piece integrated with the housing upper part 18. In particular, the lengthwise segments 28 and the respective cover elements 20 are thus also configured as a single piece, integrated with one another.

FIG. 1c illustrates a schematic longitudinal section along the plane A-A (see FIG. 1a) through the filter assembly 10 according to FIGS. 1a and 1b. There is one filter element 30 arranged in each of the filter pots 14. The filter elements 30 may be configured as round elements having a filter medium (depicted only schematically) that has been folded in the shape of a star. The filter elements 30 may then each further comprise a standpipe 32. On the lower side, the filter elements 30 are closed in a fluid-tight manner each by a bottom cover 34 that is connected to the corresponding standpipe 32. On the upper side, the filter elements 30 are supported on the housing upper part 18. Each one of the filter pots 14 is thus divided by the corresponding filter element 30 into a pre-filtration-side antechamber 36 for the fluid to be filtered, and a post-filtration chamber 38 for the filtered fluid.

The filter pots 14 are fluidically connected to one another via side wall passages 40. That is to say, the antechambers 36 in the filter pots 14 can communicate with one another through the side wall passages 40. The filter pots 14 are thus connected in parallel on the pre-filtration side. The fluid manifold 24 opens toward each of the filter pots 14. That is to say, each post-filtration chamber 38 has a fluidic connection to the manifold 24. Consequently, the fluid to be filtered can flow through the filter elements 30 in parallel.

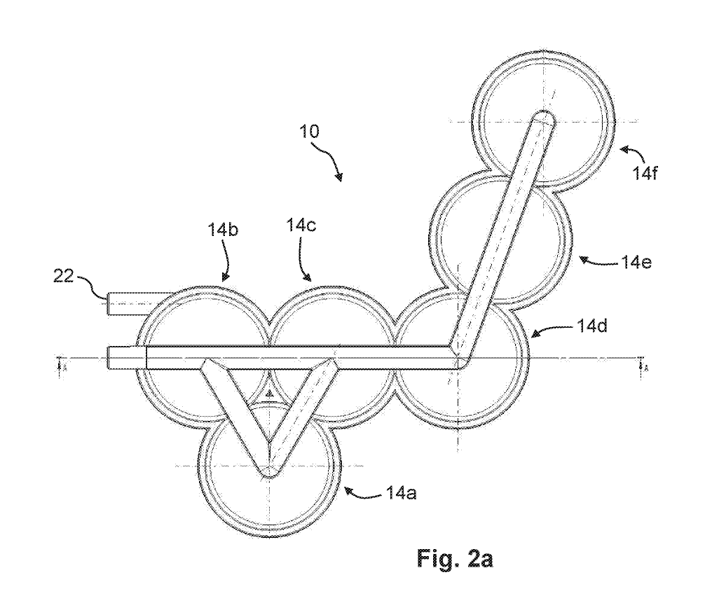

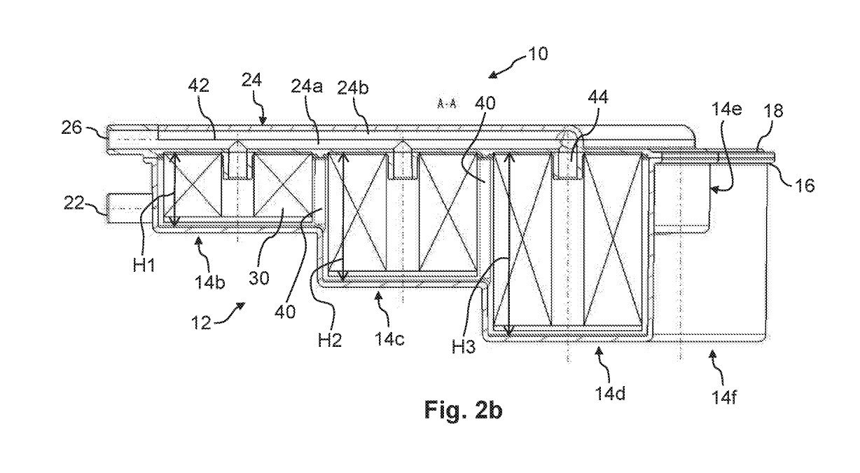

The fluid manifold 24 broadens, in the through-flow cross-section thereof, toward the fluid outlet 26. This makes it possible to prevent the flow rate of the filtered fluid in the fluid manifold 24 from increasing toward the fluid outlet 26 during operation of the filter assembly 10. Through the widening of the through-flow cross-section of the fluid manifold 24 illustrated in FIG. 2a, it is also possible to achieve a uniform through-flow through all of the filter pots 14.

FIG. 2a illustrates a schematic top view of a second embodiment of a filter assembly 10 according to the present invention. The filter assembly 10 here comprises six essentially cylindrical filter pots 14a to 14f. The filter pots 14a to 14f are arranged side by side next to one another in a shared plane. The five filter pots 14b to 14f are here arranged along a bent or angled line. The filter pot 14a is positioned next to this line, so as to be adjacent to two of the linearly-arranged filter pots 14b, 14c. A fluid inlet 22 is here arranged on a filter housing 12 of the filter assembly 10 in such a manner that fluid to be filtered is able to flow tangentially into the filter pot 14b.

FIG. 2b depicts a schematic sectional view along the plane designated as A-A in FIG. 2a, through the filter assembly 10. The filter housing 12 of the filter assembly 10 comprises a housing lower part 16 and a housing upper part 18. The filter pots 14a to 14f, which here have different depths, are configured in the housing lower part 16. That is to say, provided are filter pots 14a to 14f that have different overall heights H1, H2, H3. There is one filter element 30 arranged in each of the filter pots 14a to 14f. The filter elements 30 are configured here as round elements that extend almost above the entire overall height H1, H2, H3 of the respective filter pots 14a to 14f. The filter elements 30 may occupy, in particular, in each case more than 80% of the respective overall heights H1, H2, H3. Each of the filter pots 14a to 14f is fluidically connected to at least one of the adjacent filter pots 14a to 14f via at least one side wall passage 40. This makes it possible to distribute fluid to be filtered, which is flowing into the filter housing 12 from the inlet 22, to all of the filter pots 14a to 14f.

A fluid manifold 24 is configured on the housing upper part 18. The fluid manifold 24 is configured here so as to be longitudinally divided. The fluid manifold 24 consequently comprises here a bottom section 24a and a cover section 24b. The bottom section 24a and the cover section 24b are adjacent to one another in a longitudinal seam 42. The longitudinal seam 42 is here configured as a welding seam. It is thus possible to achieve a fluid-tight connection between the bottom section 24a and the cover section 24b. The bottom section 24a is configured as a single piece, integrated with the housing upper part 18. Connecting pieces 44 may extend one into each of the filter pots 14 from the bottom section 42. Through the connecting pieces 44, filtered fluid can flow into the fluid manifold 24. A fluid outlet 26 of the fluid manifold 24 is here configured as a single piece integrated with the bottom section 24a or the housing upper part 18.

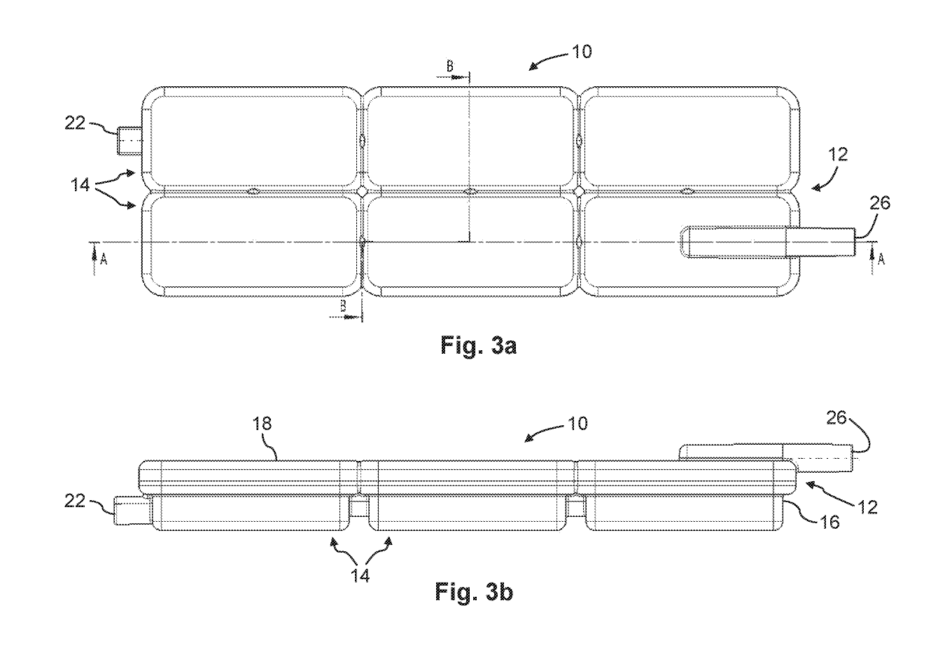

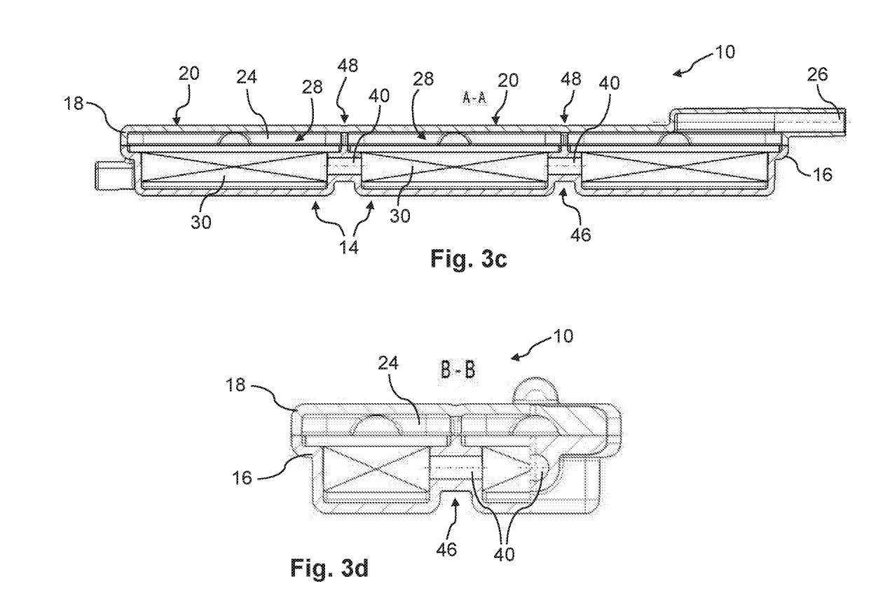

FIG. 3a illustrates a schematic top view of a third embodiment of a filter assembly 10 according to the present invention. FIG. 3b schematically depicts a side view of the filter assembly 10 of FIG. 3a. The filter assembly 10 comprises six filter pots 14 having a polygonal—here, essentially rectangular—cross-sectional shape. The filter pots 14 are here arranged next to one another in a regular rectangle pattern. Each of the filter pots 14 is thus adjacent on the narrow side and on the long side, on at least one side, to another one of the filter pots 14.

The filter pots 14 are configured in a housing lower part 16 of a filter housing 12. The housing lower part 16 is closed on the upper side by a housing upper part 18 of the filter housing 12. For this, here, the housing lower part 16 is horizontally circumferentially welded to the housing upper part 18. A fluid inlet 22 is arranged on the housing lower part 16. The housing upper part 28 has a fluid outlet 26.

FIG. 3c illustrates a schematic longitudinal view along the plane A-A (see FIG. 3a) through the filter assembly 10 according to FIGS. 3a and 3b. FIG. 3d depicts the filter assembly 10 from FIGS. 3a to 3c schematically, in the cross-section along the offset half-planes B-B (see FIG. 3a). There is one filter element 30 arranged in each of the filter pots 14. The filter elements 30 are here configured as flat elements having a filter medium (not individually depicted) that has been folded in a zigzag shape.

Adjacent filter pots 14 are fluidically connected to one another via side wall passages 40 that allow a through-flow. The side wall passages 40 are here configured as channels in partition regions 46 of the housing lower part 16 between the filter pots 40.

A fluid manifold 24 is configured in the housing upper part 18. The fluid manifold 24 opens into the fluid outlet 26. Here, there is one cover element 20 of the housing upper part 18 associated with each one of the filter pots 14. In each of the cover elements 20, a lengthwise segment 28 of the fluid manifold 24 is configured as a single piece integrated with the corresponding cover element 20. Adjacent cover elements 20 and lengthwise segments 28 are each delimited from one another by upper-side indentations 48 of the housing upper part 18.

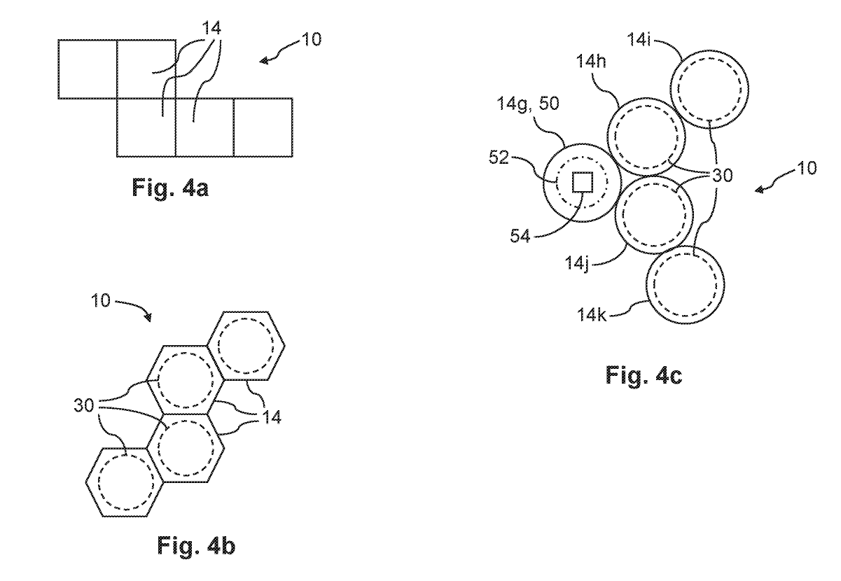

FIG. 4a illustrates a greatly-abstracted top view of a fourth embodiment of a filter assembly 10 according to the present invention. The filter assembly 10 comprises here five rectangular filter pots 14 that are arranged in two offset, parallel rows.

FIG. 4b depicts an abstracted top view of a fifth embodiment of a filter assembly 10 according to the present invention. The filter assembly 10 has here four cross-sectionally hexagonal (honeycomb-shaped) filter pots 14. The filter pots 14 are arranged in a zigzag-shaped line. Adjacent filter pots 14 therefore adjoin one another in a flat manner. A filter element 30 configured as a round element is arranged in each of the cross-sectionally hexagonal filter pots 14.

FIG. 4c illustrates an abstracted top view of a sixth embodiment of a filter assembly 10 according to the present invention. The filter assembly 10 comprises here five cylindrical filter pots 14g to 14k. A filter element 30 configured here as a round element is arranged in each of the filter pots 14h to 14k. The filter pot 14g is configured here as a central pot 50. The central pot 50 allows for serial through-flow to the filter pots 14h to 14k. Fluid to be filtered flows here first through the central pot 50 and then through one of the filter pots 14h to 14k. The filter pots 14h and 14j are then fed directly out from the filter pot 14g, configured as the central pot 50. The filter pots 14i, 14k are fluidically connected via side wall passages (not depicted) to the filter pots 14h, 14j. As an example, a water separator 52 may be arranged in the central pot 50. The water separator 50 is used to separate water entrained in the fluid from the fluid and hold same back in the central pot 50. Furthermore, a heating element 54 is arranged in the central pot 50. With the heating element 54, the fluid can be pre-heated prior to filtration, for example, in order to improve flow properties of the fluid.

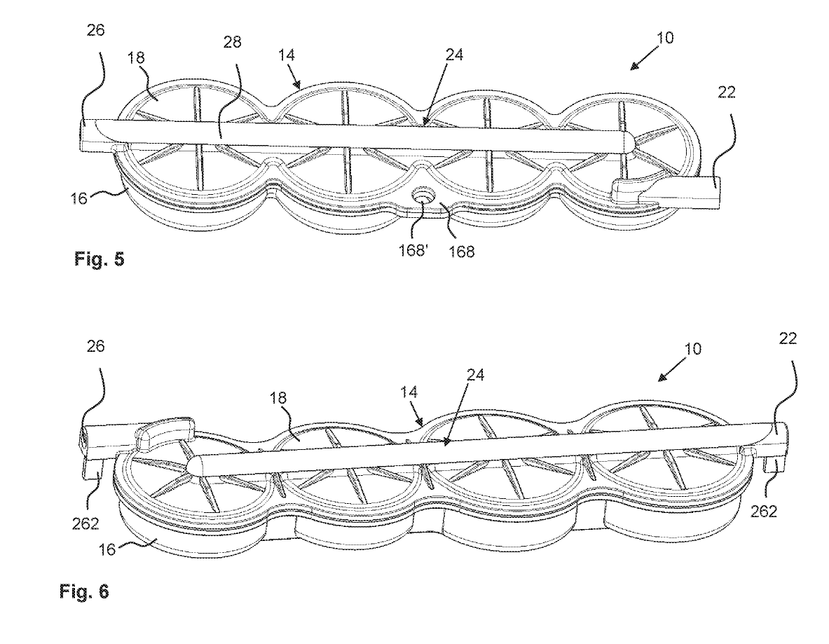

FIG. 5 illustrates another embodiment of the filter assembly 10 according to the present invention, characterized in that a bracing 168 is provided between two adjacent filter pots 14, the bracing constituting a fastening eyelet 168′ or fastening hole via which the filter assembly 10 can be mounted, for example, onto a motor vehicle, in particular, in the undercarriage region.

According to yet another embodiment depicted in FIG. 6, a connection 262 for establishing electrical contact is provided at the fluid inlet 26 and fluid outlet 22 each. This is advantageous for being able to discharge static electricity, for example, to a motor vehicle body; for this purpose, the connections 262 configured as contact tongues are connected in an electrically conductive manner. An embodiment with electrical contacts is especially advantageous if the housing is composed of an electrically conductive plastic—for example, a PA66 with GF22 and/or CF8 or the like—at least in the regions in which the connections are present.

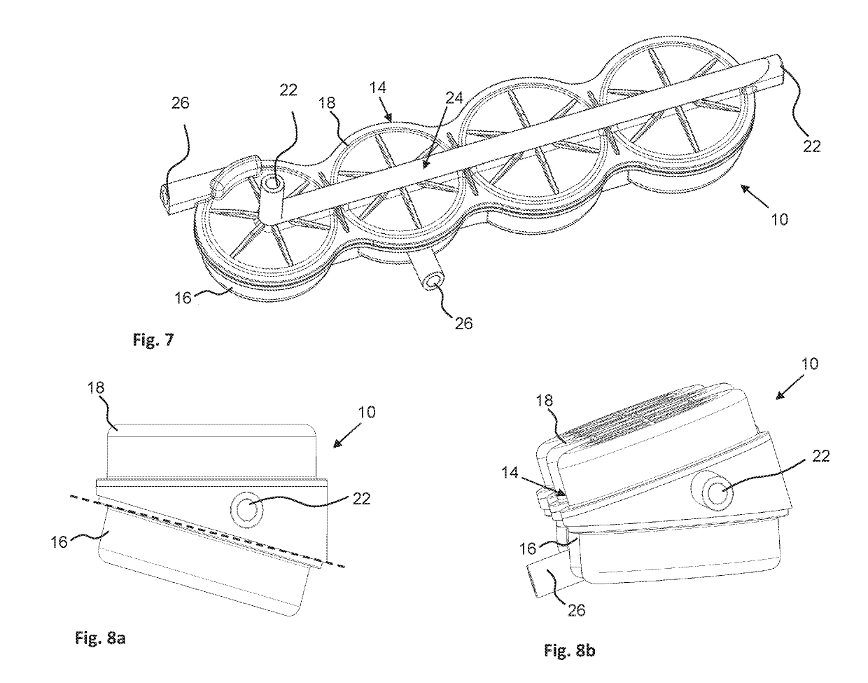

FIG. 7 illustrates an alternative embodiment of the filter assembly 10 according to the present invention, which comprises two fluid inlets 26 and two fluid outlets 22. The fluid outlets 22 are present at free ends of the manifold 24, whereas one of the fluid inlets 26 opens tangentially into a filter pot 14 that is on the left in the drawing and a second fluid inlet 26 opens radially from the left into a filter pot 14 that is second in the drawing. The fluid inlets 26 are thus fluidically connected to a radially-outer side of a filter element accommodated in the filter pot 14, while there is a flow from radially outward to radially inward through the filter element. The fluid outlets 22 may be connected, for example, to separated fuel supply systems, such as to an injection unit of an internal combustion engine and a regeneration system for a diesel particle filter, or an auxiliary heating system or the like. Of the fluid inlets 26, one may be a pre-filtration inlet from the tank, and the other may be, for example, a recirculation connection for fuel that is returned from the injection system.

FIGS. 8a and 8b illustrate an alternative embodiment in which a separation plane (dotted line) at which the housing upper part 18 and housing lower part 16 are connected runs at an angle relative to a normal direction of the filter pots 14. This enables an even better adaptation to an available installation space, for example, in the undercarriage region of a motor vehicle. In order to make the best possible use of the volume available in the filter pots 14 for filtration, the filter element used may be clipped obliquely to the longitudinal axis, so as to impart the shape of a cylinder section.

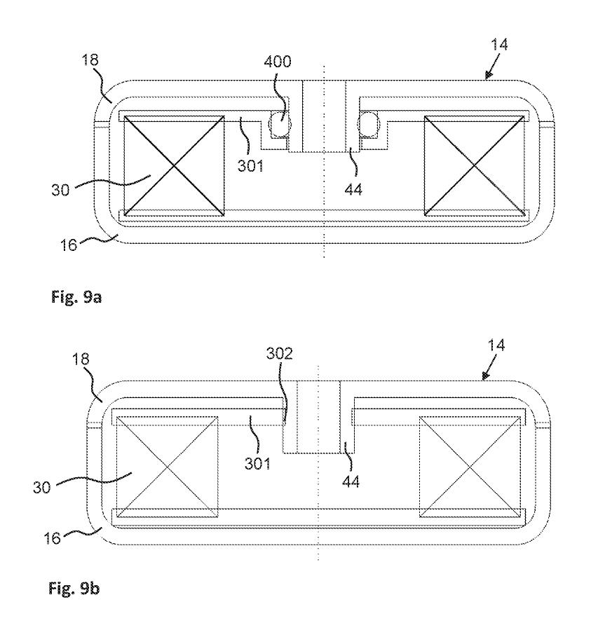

FIGS. 9a and 9b illustrate each a detailed longitudinal sectional view of a filter pot 14, in which a filter element 30 is accommodated in each case. The housing upper part 18 has in each case a socket section 44 onto which the filter element 30 is plugged in a sealing manner. In the variant illustrated in FIG. 9a, the sealing-off is provided by an O-ring 400 that is accommodated in a retracted shoulder of the end plate 301. Alternatively, the sealing-off may also be provided without an O-ring, namely, through a sealing seat 302 that is present radially inwards on the end plate 301, i.e., on the inner circumference, the end plate 301 has a sealing property, e.g., inherently due to the end plate material and/or due to an injection-molded sealing ring, e.g., made of NBR.

What is claimed is:

1. A filter assembly for a fluid to be filtered, comprising:
a filter housing having:
a housing lower part that is configured as a single piece and has at least one fluid inlet for the fluid to be filtered;
a plurality of filter pots that are arranged next to one another side by side in a shared plane and are fluidically connected to one another via side wall passages;
a housing upper part closing the plurality of filter pots having
a fluid manifold that has at least one fluid outlet for the filtered fluid flowing out from the filter pots; and
at least two filter elements that are arranged one in each of the filter pots of the filter housing.

2. The filter assembly according to claim 1, wherein
the housing upper part is configured as a single unitary piece or as a plurality of pieces with, in each case, one cover element for each filter pot.

3. The filter assembly according to claim 2, wherein
the cover elements each comprise a lengthwise segment of the fluid manifold.

4. The filter assembly according to claim 3, wherein
the cover element and the respectively-associated lengthwise segment are configured as a single piece, formed together in one piece and integrated with one another.

5. The filter assembly according to claim 1, wherein
the fluid manifold is longitudinally divided.

6. The filter assembly according to claim 1, wherein
the filter elements are clamped, embedded, integrally fastened onto, or welded onto the housing upper part, and/or the filter elements are securely plugged in a sealing manner onto a socket section of the housing upper part.

7. The filter assembly according to claim 1, wherein
the filter elements are round elements with a filter medium folded into the shape of a star, or
the filter elements are flat elements with a filter medium folded in a zigzag shape.

8. The filter assembly according to claim 1, wherein
at least two of the filter pots are fluidically connected in parallel to one another on an unfiltered side of the at last two filter pots.

9. The filter assembly according to claim 8, further comprising:
a heating element for the fluid and/or a water separator for separating out water contained in the fluid is/are arranged in one of the filter pots;
wherein the heating element is arranged in a filter pot of the plurality of filter pots that is connected for serial flow-through to another one of the plurality of filter pots of the filter housing.

10. The filter assembly according to claim 1, wherein
the housing lower part and/or the housing upper part is formed as a unitary one-piece injection-molded part;
wherein the injection-molded part is made of: a polyamide, an electrically conductive plastic;
wherein the filter assembly has at least one electrical connection or contact for discharging static electricity;

11. The filter assembly according to claim 1, wherein
a least some of the filter pots of the plurality of filter pots differ from one another in a respective overall filter pot heights and/or respective filter pot diameters thereof.

12. The filter assembly according to claim 1, wherein
the housing upper part and the housing lower part are connected to one another in a fluid-tight manner;
wherein the housing upper part and the housing lower part are a unitary component welded to one another, on a separation plane, wherein the separation plane
runs normal to a longitudinal axis of the filter pots, or
runs at an oblique angle to the longitudinal axis of the filter pots, or
is stepped into a plurality of separation plane sections;
wherein at least one of the separation plane sections runs normal to a longitudinal axis of the filter pots;
wherein at least one separation plane section runs at an oblique angle to the longitudinal axis of the filter pots.

13. The filter assembly according to claim 1, further comprising:
a bracing is provided between at least two adjacent filter pots, the bracing configured as at least one fastening eyelet or fastening tab.

14. The filter assembly according to claim 1, wherein the plurality of filter pots each have a round, elliptical, rectangular or hexagonal cross-sectional shape.

15. The filter assembly according to claim 9, wherein
the heating element is arranged in an upstream first one of the filter pots connected for serial flow-through.

16. The filter assembly according to claim 10, wherein
the at least one electrical connection or contact is arranged at the fluid inlet and/or fluid outlet.
